(19) United States
(12) Patent Application Publication
(10) Pub. No.: US 2020/0318695 A1
(43) Pub. Date: Oct. 8, 2020

(54) CLUTCH PLATE ASSEMBLY

(71) Applicant: Schaeffler Technologies AG & Co. KG, Herzogenaurach (DE)

(72) Inventors: Venkata Sivaram Bitragunta, Wooster, OH (US); Rolf Mueller, Wooster, OH (US)

(73) Assignee: Schaeffler Technologies AG & Co. KG, Herzogenaurach (DE)

(21) Appl. No.: 16/375,420

(22) Filed: Apr. 4, 2019

(51) Int. Cl. F16D 13/68; F16D 13/64

(52) U.S. Cl. CPC F16D 13/683; F16D 13/648

(57) ABSTRACT

A clutch plate is disclosed. The clutch plate includes an annular body including a plurality of splined teeth around a periphery of the annular body. Each splined tooth includes: a pair of sidewalls extending in an axial direction, a base connecting the pair of sidewalls to define a channel therebetween.

### FIELD OF INVENTION

The present invention relates to a clutch plate for a clutch assembly and more particularly relates to a modified splined tooth geometry for the clutch plate.

### BACKGROUND

Clutch assemblies are used in a variety of torque transmitting or power transmitting arrangements. In known clutch assemblies, the driving or driven clutch plates have limits with respect to torque capacity. The coefficient of friction for associated friction surfaces in these systems can be increased in a variety of ways.

One way of increasing torque capacity of clutch plate assemblies is to increase the number of clutch plates. However, increasing the number of clutch plates results in the following undesirable effects: increasing axial space, increasing inertia, increasing weight, increasing imbalances, increasing in shim tolerance, and decreasing the lift off or touch point accuracy.

Using higher strength materials for clutch plates can also increase the torque transmitting ability of a clutch assembly. However, higher strength materials are more expensive and are cost prohibitive.

It would be desirable to provide a way to increase the torque capacity of a clutch assembly that is cost effective, compact, and lightweight.

### SUMMARY

An improved clutch plate is disclosed that has increased load carry capacity. The clutch plate includes an annular body including a plurality of splined teeth around a periphery of the annular body. Each splined tooth includes: a pair of sidewalls extending in an axial direction, a base connecting the pair of sidewalls to define a channel therebetween. This geometry is generally referred to herein as a lanced splined tooth.

In one embodiment, the pair of sidewalls taper towards each other at a terminal end of the splined tooth.

A pair of curved connection portions can connect the base to a respective sidewall of the pair of sidewalls. The curved connection portions each define a radius of curvature that is within 20% of a thickness of the annular body. In one embodiment, the curved connection portions each define a radius of curvature that is equal to a thickness of the annular body.

In one embodiment, the periphery is defined along a radially inner edge of the annular body. In another embodiment, the periphery is defined along a radially outer edge of the annular body.

The clutch plate can be a separator plate or a friction plate.

The sidewalls each have an axial length, and the axial length is at least twice a thickness of the annular body. The axial length of the sidewalls is at least three times greater than the thickness of the annular body.

A gap that is defined between the pair of sidewalls is at least equal to an axial length of each of the sidewalls.

Additional embodiments are disclosed herein.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1A is a perspective, exploded view of a clutch pack assembly according to an embodiment.

FIG. 1B is a front view of a friction plate for the clutch pack assembly of FIG. 1A with lanced splined teeth.

FIG. 1C is a perspective view of the friction plate of FIG. 1B.

FIG. 1D is a top view of the friction plate of FIGS. 1B and 1C.

FIG. 1E is a magnified view of a splined tooth of the friction plate in a region of area 1E from FIG. 1D.

FIG. 1F is a top view of friction plates and separator plates of the clutch pack assembly engaged with each other.

FIG. 1G is a partial cross-sectional view of the clutch pack assembly.

FIG. 2A is a perspective exploded view of a clutch pack assembly according to another embodiment.

FIG. 2B is a perspective view of a separator plate for the clutch pack assembly of FIG. 2A.

FIG. 2C is a front view of the separator plate of FIG. 2B.

FIG. 2D is a top view of the separator plate of FIGS. 2B and 2C.

FIG. 2E is a magnified view of region 2E from FIG. 2D.

FIG. 3A is a front view of a separator plate according to another embodiment.

FIG. 3B is a perspective view of the separator plate of FIG. 3A.

FIG. 3C is a top view of the separator plate of FIGS. 3A and 3B.

FIG. 3D is a magnified view of region 3D from FIG. 3C.

FIG. 4A is a front view of a friction plate according to another embodiment.

FIG. 4B is a perspective view of the friction plate of FIG. 4A.

FIG. 4C is a top view of the friction plate of FIGS. 4A and 4B.

FIG. 4D is a magnified view of region 4D from FIG. 4C.

FIG. 5A is a perspective view of a separator plate according to another embodiment.

FIG. 5B is a front view of the separator plate of FIG. 5A.

FIG. 5C is a top view of the separator plate of FIGS. 5A and 5B.

FIG. 5D is a magnified view of region 5D from FIG. 5C.

FIG. 5E is a magnified view of a splined tooth of the separator plate of FIGS. 5A-5D.

FIG. 6A is a perspective view of a separator plate according to another embodiment.

FIG. 6B is a front view of the separator plate of FIG. 6A.

FIG. 6C is a magnified view of region 6C from FIG. 6B.

FIG. 6D is a top view of the separator plate of FIGS. 6A-6C.

FIG. 6E is a magnified view of region 6E from FIG. 6D.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

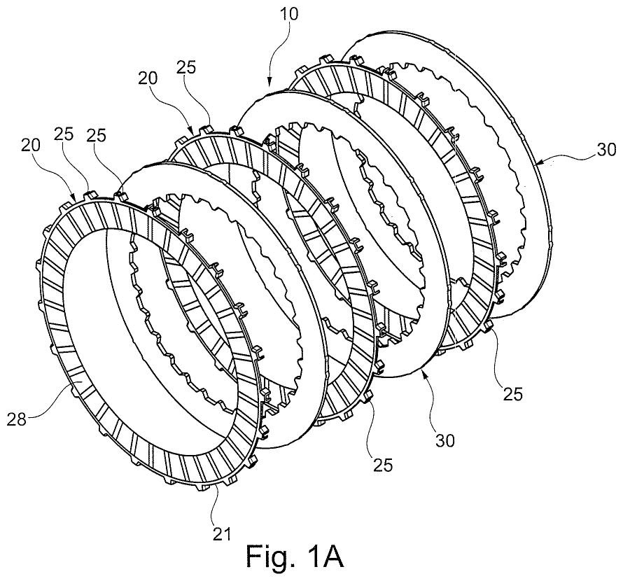

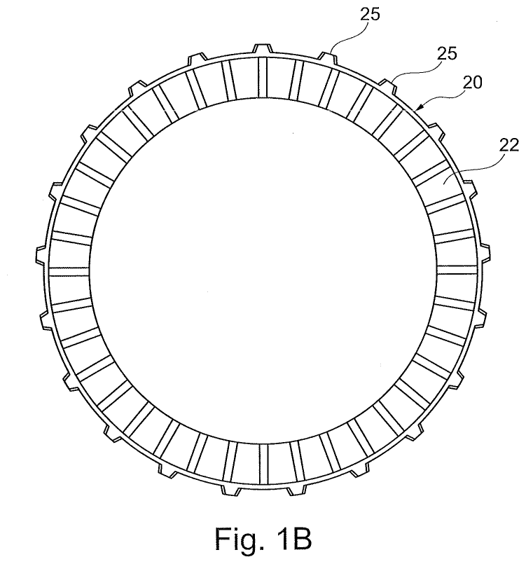

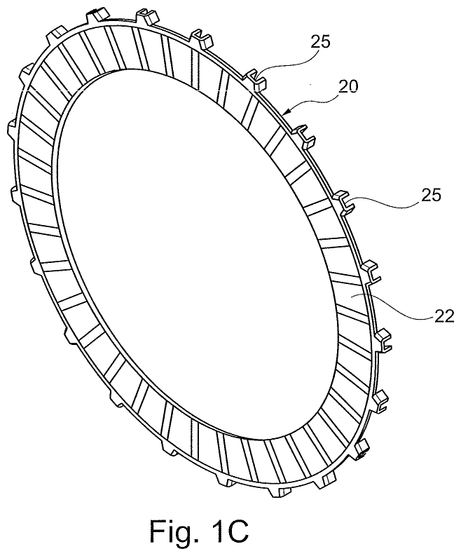

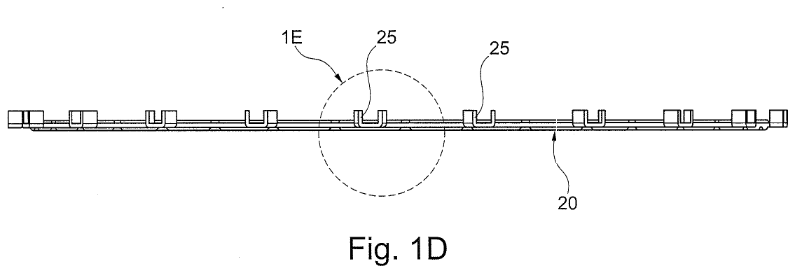

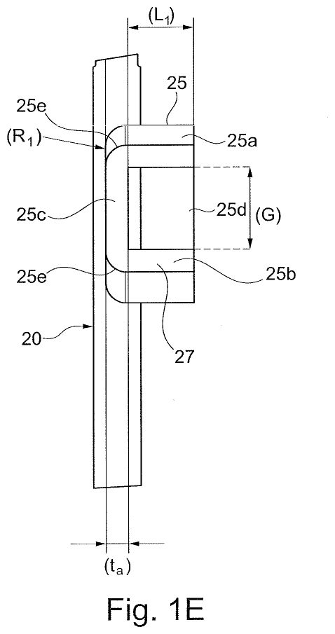

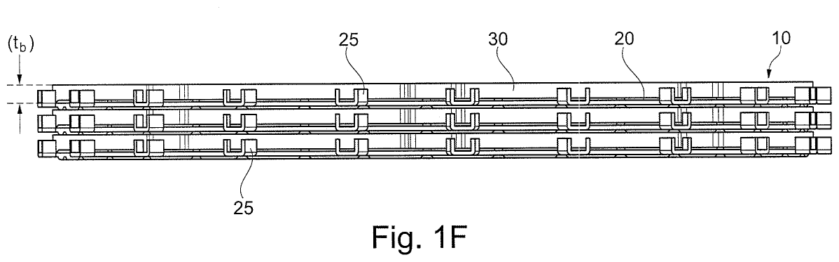

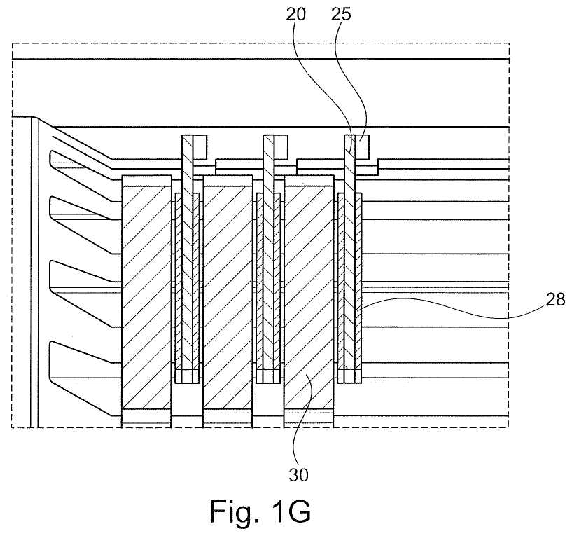

Referring to FIGS. 1A-1G, a clutch assembly 10 is illustrated. The clutch assembly 10 includes at least one clutch plate, which is either a friction plate 20 or a separator plate 30. The term clutch plate is used generically herein to refer to any plate component in the clutch assembly 10.

As shown in FIGS. 1A-1G, the friction plate 20 includes an annular body 22 including a plurality of splined teeth 25 around a periphery of the annular body 22. Each splined tooth 25 includes a pair of sidewalls 25a, 25b extending in an axial direction, and a base 25c connecting the pair of sidewalls 25a, 25b to define a channel 25d therebetween. The base 25c extends in a radial direction. These splined teeth 25, including sidewalls 25a, 25b and a base 25c, generally are referred to herein as lanced splined teeth. As shown in FIGS. 1A-1G, the pair of sidewalls 25a, 25b taper towards each other at a terminal end 27 of the splined tooth 25. As illustrated in FIG. 1E, the sidewalls 25a, 25b taper towards each other in a radially outward direction.

In the embodiment of FIGS. 1A-1G, the friction plates 20 include the splined teeth 25 including sidewalls 25a, 25b. The friction plates 20 each include a plurality of friction pads 28. The separator plates 30 in this embodiment include standard teeth, which lack any lanced profile, including sidewalls, a base, and a channel.

As shown in FIG. 1E, a pair of curved connection portions 25e connect the base 25c to a respective one of the sidewalls 25a, 25b. As shown in FIG. 1E, the curved connection portions 25e each define a radius of curvature (Rᵢ) that is within 20% of a thickness (tₐ) of the annular body 22. In one embodiment, the radius of curvature (R₁) is 0.70 mm-0.80 mm, and more preferably is 0.76 mm. In one embodiment, the thickness (tₐ) of the annular body 22 is 0.70 mm-0.80 mm, and more preferably is 0.76 mm. In one embodiment, the thickness (tₐ) of the annular body 22 and the radius of curvature (R₁) are identical. As shown in FIG. 1A, the teeth 25 are defined on a radially outer edge 21 of the friction plate 20.

The sidewalls 25a, 25b each have an axial length (L₁) that is at least twice the thickness (tₐ) of the annular body 22. In one embodiment, the axial length (L₁) of the sidewalls 25a, 25b is at least three times greater than the thickness (tₐ) of the annular body 22.

FIG. 1F illustrates a stack of friction plates 20 and separator plates 30. As shown in FIG. 1F, the separator plates 30 each have a thickness (t_{b}). The sidewalls 25a, 25b of the friction plates 20 each have an axial length (L₁) that is less than the thickness (t_{b}) of the at least one separator plate 30.

In one embodiment, a gap (G) defined between the pair of sidewalls 25a, 25b at the terminal end 27 of the splined tooth 25 is at least equal to an axial length (L₁) of each of the sidewalls 25a, 25b.

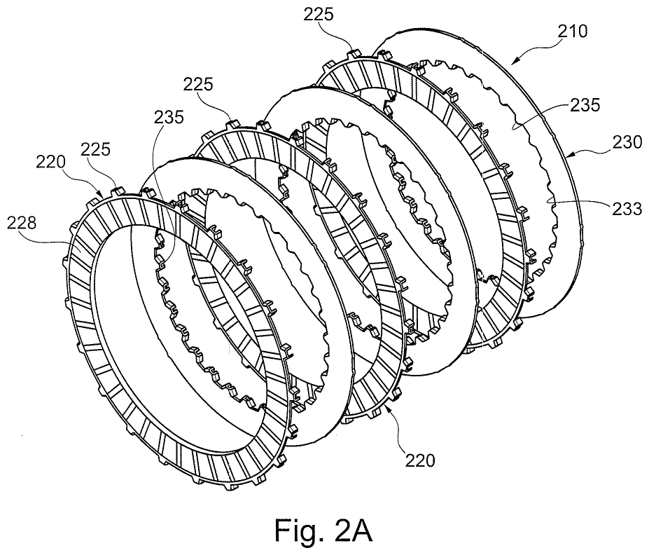

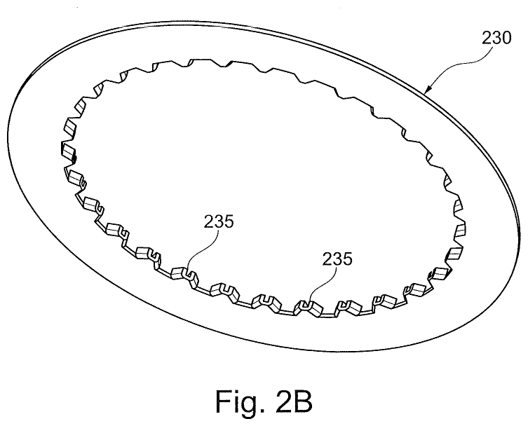

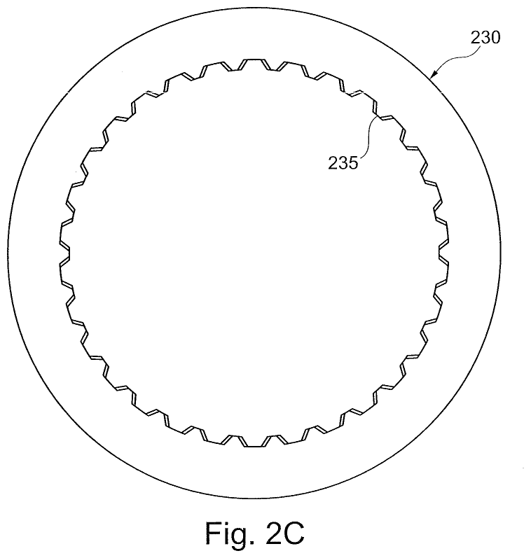

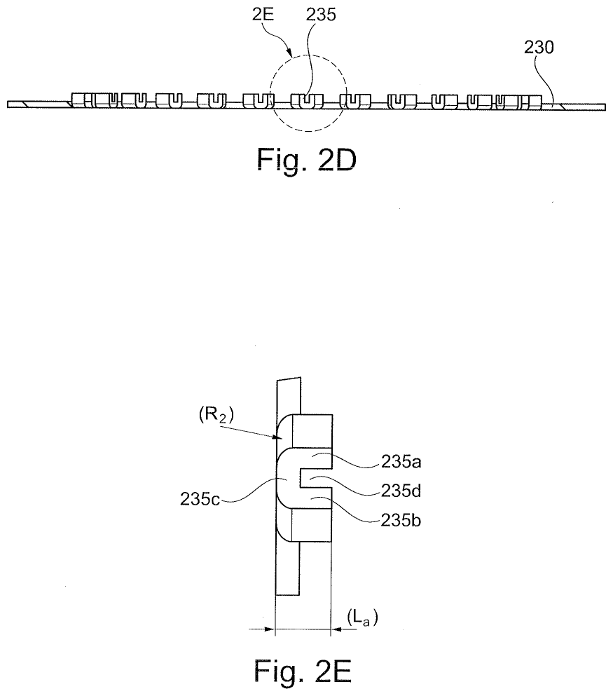

Features of FIGS. 1A-1G, which are not specifically identified or discussed in the remaining embodiments of FIGS. 2A-2E, 3A-3D, 4A-4D, 5A-5E, and 6A-6E, are otherwise similar or identical in all of the embodiments disclosed herein.

The embodiment of FIG. 2A-2E is similar to the embodiment of FIGS. 1A-1G, except the separator plates 230 also each include lanced splined teeth 235, i.e. teeth having sidewalls 235a, 235b each connected to a base 235c and defining a channel 235d. The friction plates 20 are identical in FIGS. 2A-2E as disclosed with respect to FIGS. 1A-1G. Features of the splined teeth 235, such as the profile, shape, and proportions, are otherwise substantially identical to the splined teeth 25 of FIGS. 1A-1G.

As shown in FIG. 2E, an axial length (L₂) of the sidewalls 235a, 235b is 3.0 mm-4.0 mm, and is more preferably 3.5 mm. A radius of curvature (R₂) defined between the sidewalls 235a, 235b and the base 235c is between 0.5 mm-1.0 mm, and is more preferably 0.75 mm. In FIGS. 2A-2E, the lanced splined teeth 235 of the separator plate 230 are defined on a radially inner edge 233 of the separator plates 230.

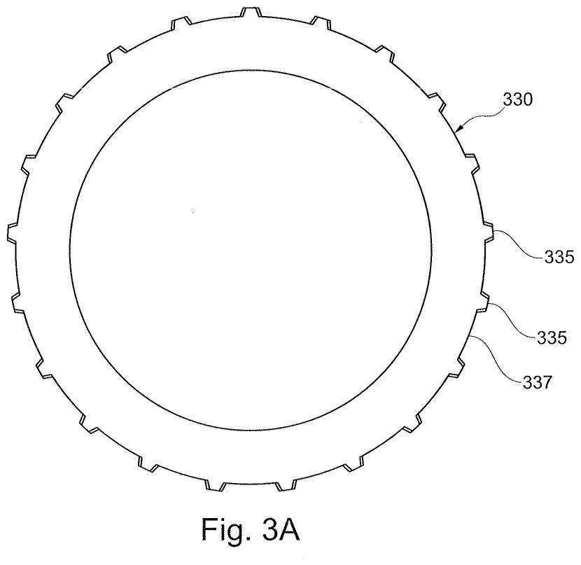

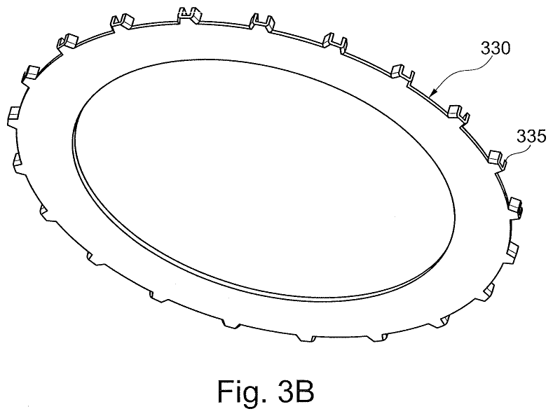

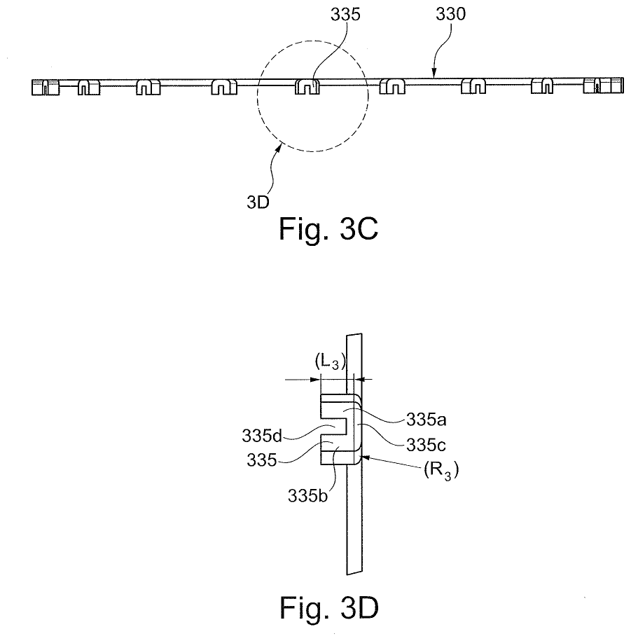

FIGS. 3A-3D illustrate another embodiment of a separator plate 330 that is similar to the separator plate 230 of FIGS. 2A-2E, except the lanced splined teeth 335 are defined on a radially outer edge 337 of the separator plate 330 instead of a radially inner edge. As shown in FIG. 3D, the sidewalls 335a, 335b are connected to a base 335c and define a channel 335d therebetween. The sidewalls 335a, 335b each have an axial length (L₃), and connection portions defined between the sidewalls 335a, 335b and the base 335c each have a radius of curvature (R₃). The axial length (L₃) is 3.0 mm-3.5 mm, and is more preferably 3.24 mm. The radius of curvature (R₃) is 0.50 mm-1.0 mm, and is more preferably 0.76 mm.

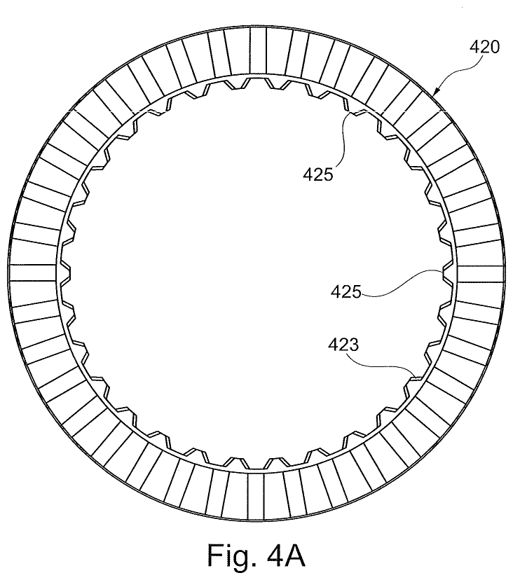

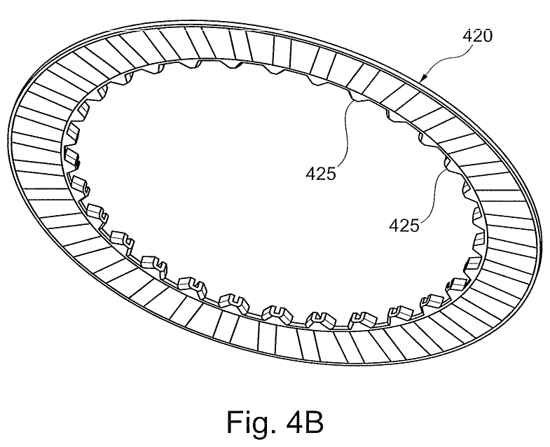

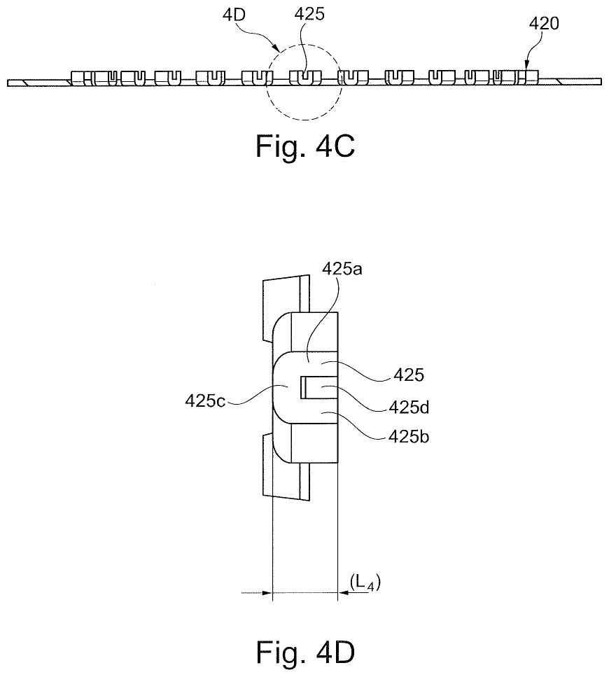

The embodiment of FIGS. 4A-4D includes a friction plate 420 having lanced splined teeth 425 defined on a radially inner edge 423. Each of the lanced splined teeth 425 include sidewalls 425a, 425b a base 425c, and a channel 425d therebetween. The sidewalls 425a, 425b each have an axial length (L₄), which is 3.0 mm-4.0 mm, and more preferably is 3.5 mm. Features of the friction plate 420 are otherwise identical to the friction plate 20 of FIGS. 1A-1G.

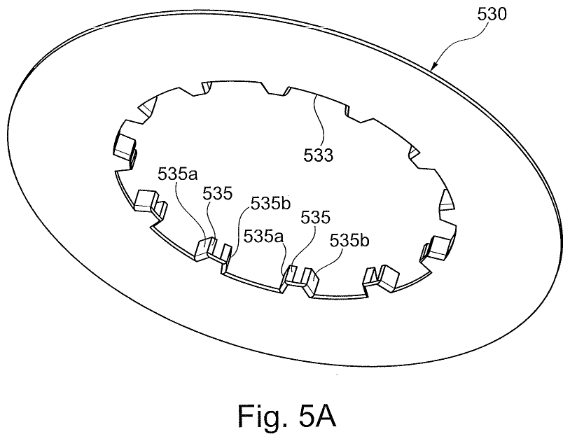

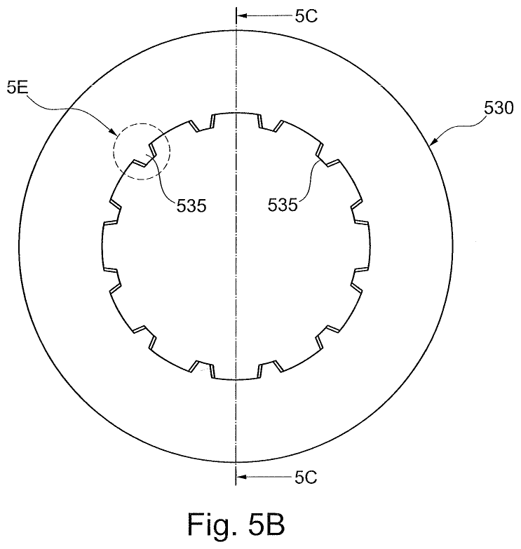

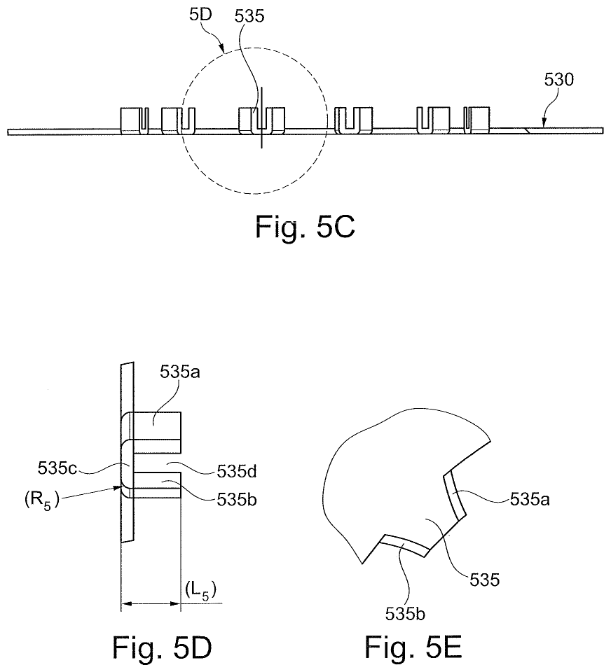

As shown in FIGS. 5A-5E, an alternative type of a lanced splined tooth 535 is defined on a radially inner edge 533 of a separator plate 530. Each lanced splined tooth 535 includes curved sidewalls 535a, 535b connected by a base 535c and defining a channel 535d therebetween. The sidewalls 535a, 535b have an axial length (L₅) of 3.5 mm-4.0 mm, and more preferably 3.76 mm. A radius of curvature (R₅) is defined between the base 535c and each sidewall 535a, 535b, and the radius of curvature (R₅) is at least 0.50 mm. Curvature of the sidewalls 535a, 535b is dependent on the thickness of the plate 530. In one embodiment, the curvature of the sidewalls 535a, 535b is half of a thickness of the separator plate 530. In one embodiment, a thickness of the separator plate 530 can be 0.5 mm-3.0 mm.

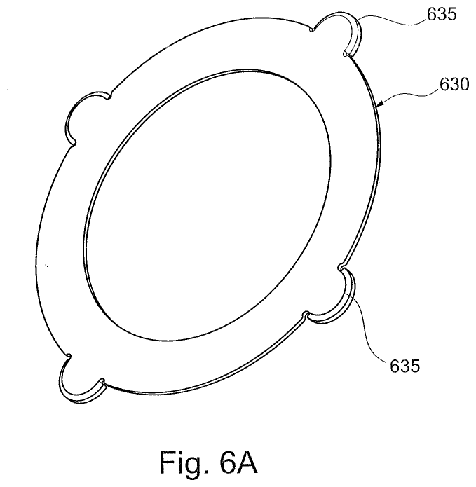

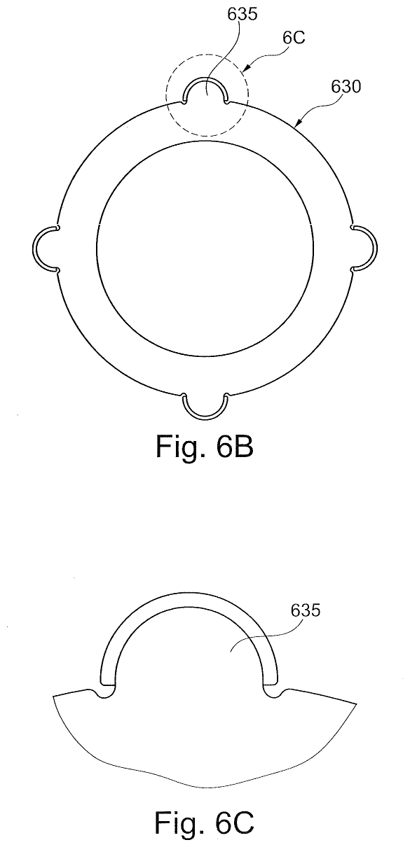

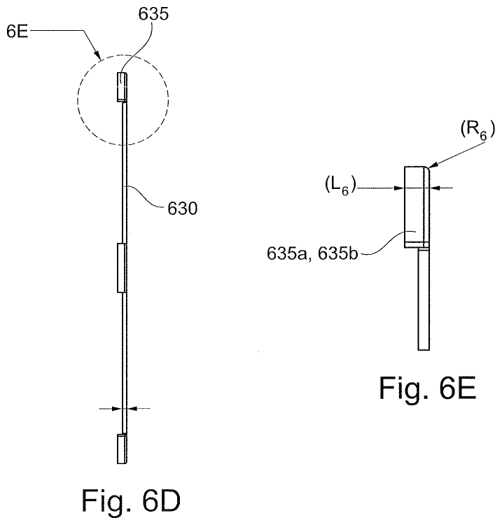

An embodiment shown in FIGS. 6A-6E illustrates a separator plate 630 including lanced splined teeth 635 having a rounded profile. As shown in FIG. 6E, sidewalls 635a, 635b each have an axial length (L₆) of 2.0 mm-4.5 mm, and preferably 3.5 mm. Thickness of the separator plate 630 is preferably 1.0 mm-3.0 mm. A radius of curvature (R₆) is defined between a connection portion of the sidewalls 635a, 635b, and the radius of curvature (R₆) is between 0.5 mm-1.5 mm.

Each of the lanced splined teeth illustrated in FIGS. 1A-1G, 2A-2E, 3A-3D, 4A-4D, 5A-5E, and 6A-6E are adapted or configured to engage with a corresponding recess or pocket formed in an input device or output device.

Each of the lanced splined teeth illustrated in FIGS. 1A-1G, 2A-2E, 3A-3D, 4A-4D, 5A-5E, and 6A-6E generally increase the load carrying capacity of the associated clutch assemblies. Torque capacity is generally increased by at least 50% based on the geometry of the lanced splined teeth, axial space requirements are reduced up to 2.0 mm per clutch assembly, and the unit loading of each lanced splined tooth is decreased by 60%. Based on the embodiments disclosed here, the torque capacity for the clutch packs using lanced splined teeth is generally increased from 500 N-m to 1,100 N-m. Based on the lanced splined teeth disclosed herein, the spline engagement length is increase by at least a factor of two. As the effective spline length is increased, torque capacity of the plates is also increased.

In one embodiment, the lanced splined teeth provide an effective engagement length of 3.0 mm, which is achieved by a single plate having a thickness of 1.5 mm.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

### LOG OF REFERRENCE NUMERALS

Clutch assembly 10

Friction plate 20

Outer edge 21

Annular body 22

Inner edge 23

Splined teeth 25

Sidewalls 25a, 25b

Base 25c

Channel 25d

Curved connection portions 25e

Terminal ends 27

Friction pad 28

Separator plate 30

Inner edge 33

Splined teeth 35

Sidewalls 35a, 35b

Base 35c

Channel 35d

Outer edge 37

What is claimed is:

1. A clutch plate comprising:
an annular body including a plurality of splined teeth around a periphery of the annular body,
each splined tooth of the plurality of splined teeth including:
a pair of sidewalls extending in an axial direction, and
a base connecting the pair of sidewalls to define a channel therebetween.

2. The clutch plate of claim 1, wherein the pair of sidewalls taper towards each other at a terminal end of the splined tooth.

3. The clutch plate of claim 1, wherein a pair of curved connection portions connect the base to a respective sidewall of the pair of sidewalls.

4. The clutch plate of claim 3, wherein the curved connection portions each define a radius of curvature that is within 20% of a thickness of the annular body.

5. The clutch plate of claim 3, wherein the curved connection portions each define a radius of curvature that is equal to a thickness of the annular body.

6. The clutch plate of claim 1, wherein the periphery is defined along a radially inner edge of the annular body.

7. The clutch plate of claim 1, wherein the periphery is defined along a radially outer edge of the annular body.

8. The clutch plate of claim 1, wherein the clutch plate is a separator plate or a friction plate.

9. The clutch plate of claim 1, wherein the sidewalls each have an axial length, and the axial length is at least twice a thickness of the annular body.

10. The clutch plate of claim 9, wherein the axial length of the sidewalls is at least three times greater than the thickness of the annular body.

11. The clutch plate of claim 1, wherein a gap defined between the pair of sidewalls is at least equal to an axial length of each of the sidewalls.

12. A clutch plate assembly comprising:
at least one separator plate;
at least one friction plate including:
an annular body having a plurality of splined teeth around a periphery of the annular body,
each splined tooth of the plurality of splined teeth including:
a pair of sidewalls extending in an axial direction, and
a base connecting the pair of sidewalls to define a channel therebetween.

13. The clutch plate assembly of claim 12, wherein the pair of sidewalls taper towards each other at a terminal end of the splined tooth.

14. The clutch plate assembly of claim 12, wherein the sidewalls each have an axial length, and the axial length is less than a thickness of the at least one separator plate.

15. The clutch plate assembly of claim 12, wherein the at least one friction plate includes a plurality of friction pads.

16. The clutch plate assembly of claim 12, wherein a pair of curved connection portions connect the base to a respective sidewall of the pair of sidewalls, and
the curved connection portions each define a radius of curvature that is equal to a thickness of the annular body.

17. The clutch plate assembly of claim 12, wherein the periphery is defined along a radially outer edge of the at least one friction plate.

18. The clutch plate assembly of claim 12, wherein the sidewalls each have an axial length, and the axial length is at least three times greater than a thickness of the annular body.
